(19) United States
(12) Patent Application Publication
(10) Pub. No.: US 2024/0159358 A1
(43) Pub. Date: May 16, 2024

(54) Compressed Air Supply Device

(71) Applicant: KOGANEI CORPORATION, Tokyo (JP)

(72) Inventors: Akiyoshi HORIKAWA, Tokyo (JP); Yu TAKEBAYASHI, Tokyo (JP); Rikuta FUJII, Tokyo (JP)

(73) Assignee: KOGANEI CORPORATION, Tokyo (JP)

(21) Appl. No.: 18/417,601

(22) Filed: Jan. 19, 2024

Related U.S. Application Data
(63) Continuation of application No. PCT/JP2022/026848, filed on Jul. 6, 2022.

(30) Foreign Application Priority Data
Jul. 20, 2021 (JP) 2021-119823

(51) Int. Cl. F17C 5/06; F16K 31/06; F17C 13/04

(52) U.S. Cl. CPC F17C 5/06; F16K 31/0644; F17C 13/04

(57) ABSTRACT

An air supply device has a simple structure supplying compressed air to pneumatic equipment incorporated into a moving device from outside. The compressed air supply device includes: an air supply head having an opposite surface opposing a connection surface; an air supply rod in the air supply head so as to be capable of reciprocating between a projecting position where a projecting surface protrudes from the opposite surface and a retraction position where the projecting surface retracts from the projecting position; an on-off valve causing a compressed air supply source and an air inflow path to communicate with each other via an air guide path when the connection surface is abutted against the projecting surface; a first magnet on the connection surface; and a second magnet on the opposite surface, and by the magnetic attraction of both first and second magnets, an outlet and an inlet are centered.

### CROSS-REFERENCE TO RELATED APPLICATIONS

This is a continuing application, under 35 U.S.C. § 120, of copending international application No. PCT/JP2022/026848, filed Jul. 6, 2022, which designated the United States and was not published in English; this application also claims the priority, under 35 U.S.C. § 119, of Japan patent application No. 2021-119823 filed on Jul. 20, 2021; the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present systems, apparatuses, and methods lie in the field of gas supply. The present disclosure relates to a compressed air supply device for supplying compressed air to pneumatic equipment incorporated in a moving device.

### BACKGROUND OF THE INVENTION

Self-propelled dollies (AGV) for transporting workpieces and processed objects in factories include types of providing: actuators such as air hands for gripping the processed objects; and a pneumatic control device for controlling the pneumatic actuators. In addition, working robots that move the processed objects and that perform various types of work such as welding include types of providing the pneumatic actuators for driving the robot arms and air hands, and the pneumatic control device that controls the pneumatic control device. When using the pneumatic actuators and the pneumatic control device on the self-propelled dolly, it is necessary to provide the pneumatic equipment or mount an air tank to supply compressed air. If an air tank is provided in the moving device such as a self-propelled dolly in which the pneumatic actuator and the pneumatic control device, compressed air can be supplied to the pneumatic actuator and the pneumatic control device. When a remaining amount of compressed air in the air tank is low, compressed air is supplied into the air tank by the compressed air supply equipment. Meanwhile, in the moving device that does not have the air tank, the compressed air is directly supplied to the pneumatic actuator and the pneumatic control device by the compressed air supply device when the pneumatic actuator and the pneumatic control device are operated.

Japanese Utility Model Application Laid-open No. S63-97791 discloses a supply device for supplying electric energy and pneumatic energy to automatic guided vehicles in automobile production plants. The supply device is guided by guide rails and is movable along the automatic guided vehicle, and a connector of the supply device is provided with a synchronization bar and a guide hole. The connector of the automatic guided vehicle is provided with a synchronization hole into which the synchronization bar is inserted and a guide bar that is inserted into the guide hole. Further, the connector of the automatic guided vehicle is provided with a reception coupler for receiving air energy from a supply coupler of the supply device, and the reception coupler is inserted into the supply coupler when supplying air energy from the supply device to the automatic guided vehicle. The reception coupler is connected to an accumulator which is the pneumatic equipment mounted on the automatic guided vehicle.

In the supply device disclosed in Japanese Utility Model Application Laid-open No. S63-97791, in order to position the supply coupler and the reception coupler, the synchronization bar is inserted into the synchronization hole, and then the guide bar is inserted into the guide hole, thereby making a position mechanism complicated. Further, if the connector of the supply device is provided with the synchronization bar and the guide hole and the connector of the automatic guided vehicle is provided with the synchronization hole and the guide bar, the respective connectors are not avoided making larger.

Japanese Patent Application Laid-open No. 2015-211997 discloses a work system in which a traveling carriage mounted by the work robot is moved to a plurality of work stations by guidance of a magnetic tape. An attachment of the travelling carriage is provided with a male coupling to which air is supplied and a magnetic attraction type terminal connector as power receiving equipment. A slide box movably provided along the guide rail is provided with a female coupling for air supply and a magnetic attraction type terminal connector as power supply equipment. The male coupling is inserted into the female coupling by causing the slide box to approach toward the work carriage, and compressed air is supplied to the pneumatic actuators of the work robot mounted on the work carriage.

In the work system disclosed in Japanese Patent Application Laid-open No. 2015-211997, the traveling robot pulls the slide box toward its own attachment, thereby connecting the female coupling and the male coupling to perform air supply and signal connection. Also when separating the female coupling and the male coupling, the traveling robot causes the slide box to secede from the attachment. In this work system, the male and female couplings are connected and separated by a robot operation guided by a magnetic tape(s). The self-propelled dolly without the robot cannot position the attachment and the slide box and detach the magnet to cause the slide box to secede.

It is also conceivable to mount an air compressor on the self-propelled dolly, but weight of the air compressor increases and a storage battery of the self-propelled dolly is consumed.

Thus, a need exists to overcome the problems with the prior art systems, designs, and processes as discussed above.

### SUMMARY OF THE INVENTION

The systems, apparatuses, and methods described provide a compressed air supply device that overcomes the hereinafore-mentioned disadvantages of the heretofore-known devices and methods of this general type and that provide such features with a simple structure, which is capable of supplying compressed air from outside to the pneumatic equipment incorporated in the moving device without using storage battery energy of the moving device.

A compressed air supply device described herein, which supplies compressed air to pneumatic equipment mounted on a moving device from an inlet of an air inflow path that communicates with the pneumatic equipment, includes: an air supply head provided with an opposite surface opposing a connection surface that is provided with the inlet, and attached to a support member; an air supply rod reciprocably arranged at the air supply head between a projecting position where the projecting surface protrudes from the opposite surface and a retraction position where the projecting surface recedes from the projection position; an air guide path formed in the air supply rod and provided with an outlet on the projecting surface; an on-off valve blocking communication between a compressed air supply source and the air guide path when the projecting surface separates from the connection surface, and causing the compressed air supply source and the air inflow path to communicate with each other via the air guide path when the connection surface is abutted against the projecting surface; a first magnet provided on the connection surface; and a second magnet provided on the opposite surface, and magnetically attracted at the first magnetic to center the outlet to the inlet.

The air supply head supplying compressed air from the connection surface of the moving device has a cylinder body movably provided with an air supply rod, the cylinder body is provided with an opposite surface opposing the connection surface. The connection surface is provided with a first magnet, the opposition surface is provided with a second magnet, and by attraction of the both magnets, an outlet of an air guide path formed in the air supply rod is positioned with respect to an inlet of the air inflow path. The compressed air can be supplied to the moving object by abutting on the air supply rod with respect to the connection surface of the moving object, so that the compressed air can be supplied to the moving object by a device with a simple structure.

With the foregoing and other objects in view, there is provided, a compressed air supply device supplying compressed air to pneumatic equipment mounted on a moving device from an inlet of an air inflow path that communicates with the pneumatic equipment, the compressed air supply device comprising an air supply head provided with an opposite surface opposing a connection surface that is provided with the inlet, and attached to a support member, an air supply rod reciprocably arranged at the air supply head between a projecting position where the projecting surface protrudes from the opposite surface and a retraction position where the projecting surface recedes from the projection position, an air guide path formed in the air supply rod and provided with an outlet on the projecting surface, an on-off valve blocking communication between a compressed air supply source and the air guide path when the connection surface separates from the connection surface, and causing the compressed air supply source and the air inflow path to communicate with each other via the air guide path when the connection surface is abutted against the projecting surface, a first magnet provided on the connection surface, and a second magnet provided on the opposite surface, and magnetically attracted at the first magnetic to center the outlet to the inlet.

In accordance with another feature, the on-off valve is provided in the air supply rod and the on-off valve blocks communication between the compressed air supply source and the air guide path when the air supply rod is at the projecting position, and communicates with the compressed air supply source and the air inflow path via the air guide path when the connection surface is abutted against the projecting surface and the air supply rod is at retraction position.

In accordance with a further feature, a separation rod is provided in the air supply head, the separation rod causing the air supply head to separate from the connection surface against an absorption force of the first magnetic and the second magnetic.

In accordance with an added feature, there is provided a separation piston movably attached into a cylinder hole formed in the air supply head, and wherein a hollow separation piston in which the air supply rod is movably incorporated is provided on the separation piston and the separation rod is driven by the separation piston.

In accordance with an additional feature, the air supply head is provided with a separation cylinder for driving the separation rod.

In accordance with yet another feature, there is provided an air supply piston movably attached in a cylinder hole formed in the air supply head and integrally provided with the air supply rod, and wherein the on-off valve is provided in an air supply path connected to the air guide path of the air supply rod and the air supply piston moves between a retraction position where the projecting surface contacts with the connection surface and a projection position where the air supply head is separated from the connection surface.

In accordance with yet a further feature, a surface of the first magnet is substantially flush with the connection surface, and a surface of the second magnet is substantially flush with the opposite surface.

In accordance with yet an added feature, an abutment seal member is provided on at least one of the connection surface and the projecting surface.

In accordance with a concomitant feature, one or both of the first magnet and the second magnet are electromagnets.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems, apparatuses, and methods. Advantages of embodiments of the systems, apparatuses, and methods will be apparent from the following detailed description of the exemplary embodiments thereof, which description should be considered in conjunction with the accompanying drawings in which:

FIG. 1 is a perspective view showing one example of a compressed air supply device suppling compressed air to a self-propelled dolly serving as a moving device and pneumatic equipment provided thereon;

FIG. 2A is a front view showing a state in which the self-propelled dolly approaches the compressed air supply device;

FIG. 2B is a front view showing a state in which the compressed air supply device contacts with the self-propelled dolly;

FIG. 3A is a cross-sectional view showing a state in which an air supply head of the compressed air supply device of one embodiment opposes the self-propelled dolly;

FIG. 3B is a cross-sectional view showing a state in which the air supply head of the compressed air supply device is abutted against the self-propelled dolly;

FIG. 4A is a cross-sectional view showing an air supply head of a compressed air supply device according to another embodiment;

FIG. 4B is a cross-sectional view showing a state in which the air supply head shown in FIG. 4A abuts on the self-propelled dolly;

FIG. 4C is a cross-sectional view showing a state in which a magnetic attraction of a first magnet and a second magnet is released by a separation rod;

FIG. 5 is a cross-sectional view showing an air supply head of the compressed air supply device according to another embodiment; and

FIG. 6 is a cross-sectional view showing an air supply head of a compressed air supply device according to yet another embodiment.

### DETAILED DESCRIPTION OF THE EMBODIMENTS

Hereinafter, embodiments of the present invention will be described in detail with reference to the drawings. In each embodiment shown in the drawings, the same reference numerals are given to members having commonality.

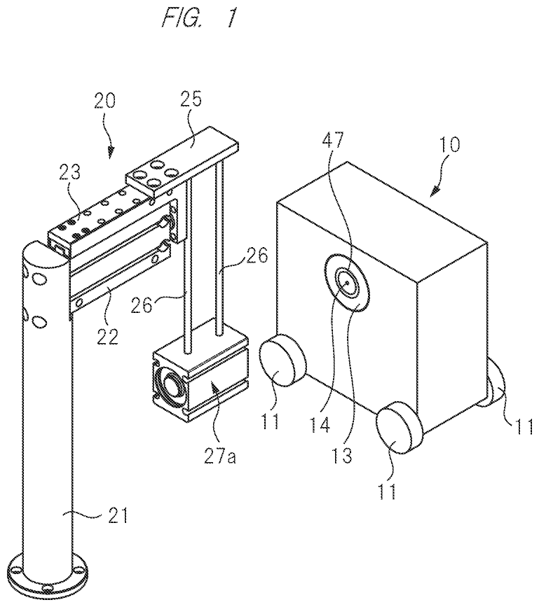

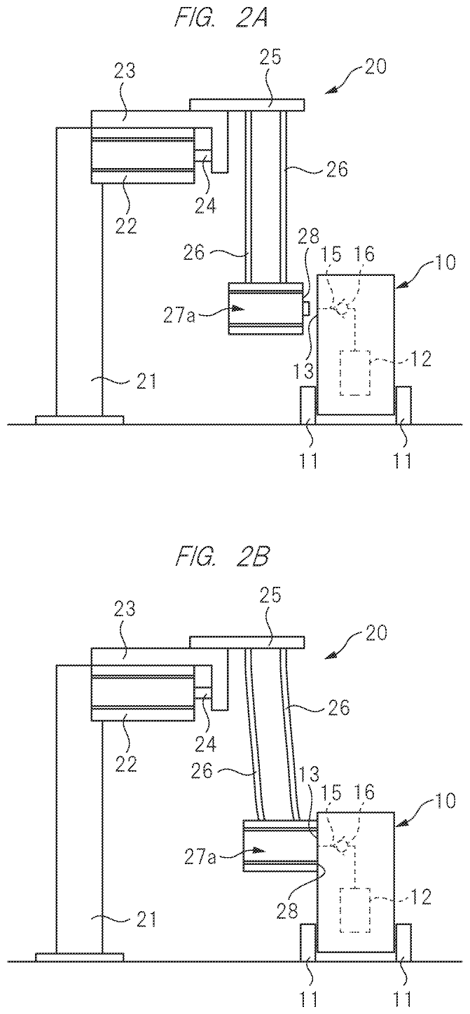

As shown in FIG. 1, a compressed air supply device 20 is applied to supply compressed air to pneumatic equipment provided in a self-propelled dolly 10 as a moving device, that is, a moving object. The self-propelled dolly 10 also called an automatic guided vehicle has wheels 11, and the wheels 11 are driven by an electric motor by a battery serving as a power source which is incorporated in the self-propelled dolly 10. As shown in FIGS. 2A and 2B, an air tank 12 as pneumatic equipment is provided in the self-propelled dolly 10, and a pneumatic actuator using, as a drive source, compressed air injected into the air tank 12 and a pneumatic control device for controlling the pneumatic actuator are provided on the self-propelled dolly 10 as another pneumatic equipment. The pneumatic actuator is a cylinder for driving a chuck or a hand that grips processed objects, a vacuum cup for sucking and holding the processed objects, and the like. The pneumatic control device is an on-off valve, a channel switching valve, and the like. However, the pneumatic actuator and the pneumatic control device are omitted from the drawing.

An inlet 14 is provided in a connection surface 13 on a side surface of the self-propelled dolly 10. As shown in FIGS. 2A and 2B, the inlet 14 communicates with an air tank 12 as a pneumatic device via the air inflow path 15 provided in the self-propelled dolly 10. A check valve 16 is provided in the air inflow path 15. The check valve 16 allows the compressed air to flow from the inlet 14 toward the air tank 12, and blocks a flow in an opposite direction.

The compressed air supply device 20 has an air pressure pneumatic cylinder 22 attached to a support member 21. A linear guide 23 is movably mounted on the pneumatic cylinder 22, and the linear guide 23 is connected to a rod 24 of the pneumatic cylinder 22. A support plate 25 is attached to the linear guide 23, and an elastic member 26 made of a coil spring, a rubber rod material, or the like is attached to the support plate 25. An air supply head 27a is attached on a lower end portion of the elastic member 26. The air supply head 27a becomes a state of being suspended from the support member 21 via the elastic member 26 and is attached thereto, so that air supply head 27a is movable in a horizontal direction.

The air supply rod 27a is formed by a pressure cylinder, and an end surface on a tip side is a flat opposite surface 28 opposing a connection surface 13 of the self-propelled dolly 10. The supply of compressed air to the self-propelled dolly 10 from the air supply head 27a of the compressed air supply device 20 is required to oppose an air flow outlet provided in the air supply head 27a with respect to an inlet 14 of an air inflow path 15 with higher accuracy. However, in a case of the self-propelled dolly 10, even if the self-propelled dolly is caused to approach the air supply head 27a, the inlet 14 cannot be positioned at a predetermined position of the air supply head 27a with higher accuracy and position displacement does not avoid to occur.

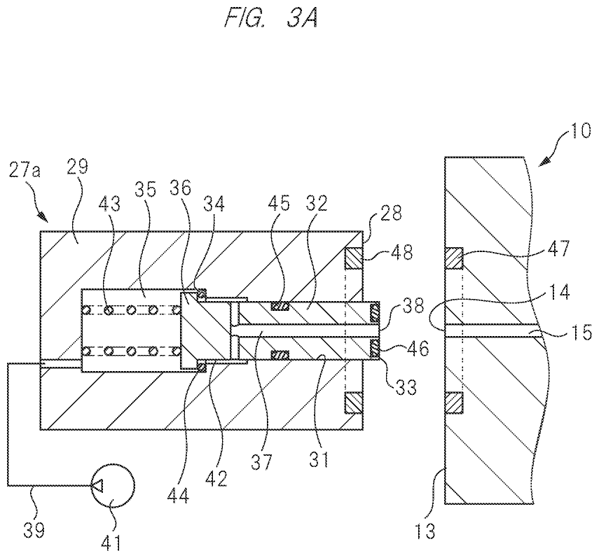

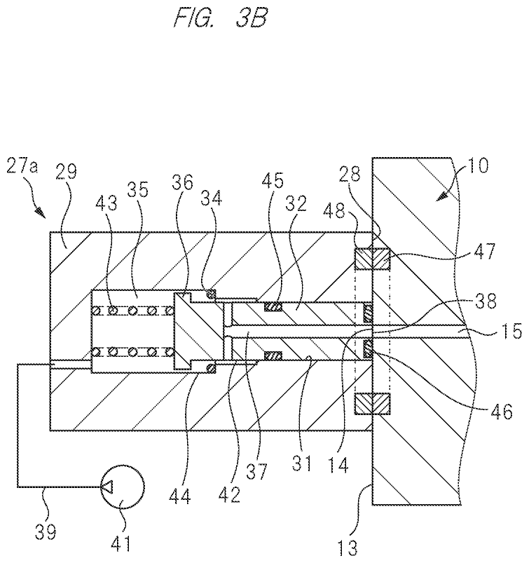

As shown in FIGS. 3A and 3B, the air supply head 27a has a cylinder body 29, a guide hole 31 opening to the opposite surface 28 is formed in the cylinder body 29, and an air supply rod 32 is attached to the guide hole 31 reciprocably in an axial direction. As shown in FIG. 3A, the air supply rod 32 moves between a projecting position where a tip surface of the air supply rod 32, that is, a projecting surface 33 protrudes from the opposite surface 28 and a retraction position where the projection surface 33 is retracted from this projecting position. A spring chamber 35 communicating with the guide hole 31 via a radial step surface 34 is formed in the cylinder body 29, and an inner diameter of the spring chamber 35 is larger than an inner diameter of the guide hole 31. An on-off valve 36 is formed by a large-diameter portion provided at a back end portion of the air supply rod 32, and the on-off valve 36 moves in the spring chamber 35 while opening and closing.

An air guide path 37 is formed in the air supply rod 32 to extend in the axial direction, and an outlet 38 of the air guide path 37 is formed in the projecting surface 33. The spring chamber 35 is connected to a compressed air supply source 41 by the air supply path 39, and compressed air is supplied to the spring chamber 35. A communication path 42 is formed between a base end portion of the air supply rod 32 and the cylinder body 29, and the communication path 42 communicates with the spring chamber 35 and the air guide path 37.

A compression coil spring 43 is arranged in the spring chamber 35, a tip of the compression coil spring 43 abuts on an end surface of the on-off valve 36, that is, a back end surface of the air supply rod 32, and a back end of the compression coil spring 43 abuts on a bottom wall of the cylinder body 29. The compression coil spring 43 applies a spring force to the air supply rod 32 in a direction in which the projecting surface 33 protrudes from the opposite surface 28. An on-off valve sealing member 44 is arranged between the on-off valve 36 and the step surface 34, and the compression coil spring 43 presses the on-off valve 36 against the step surface 34 via the on-off valve sealing member 44, and the communication with the spring chamber 35 and the air guide path 37 is blocked. At this time, the projecting surface 33 of the air supply rod 32 protrudes from the opposite surface 28 as shown in FIG. 3A. Meanwhile, when the projecting surface 33 is pressed by the connection surface 13 of the self-propelled dolly 10, as shown in FIG. 3B, the on-off valve 36 moves backward against the spring force and the spring chamber 35 and the air guide path 37 communicate with each other via the communication path 42 by opening the communication path 42.

A sealing member 45 provided on an outer peripheral portion of the air supply rod 32 seals a region between an outer peripheral surface of the air supply rod 32 and an inner peripheral surface of the guide hole 31. A region between the projecting surface 33 of the air supply rod 32 and the connection surface 14 is sealed by an abutment sealing member 46 provided at the tip portion of the air supply rod 32. Therefore, as shown in FIG. 3B, when the projecting surface 33 of the air supply rod 32 is abutted against the connection surface 13 and moves backward, the spring chamber 35 and the air guide path 37 become a state of communicating with each other via the communication path 42. At the same time, the region between the projecting surface 33 and the connection surface 13 is sealed, and the compressed air supplied from the compressed air supply source 41 is supplied to the air tank 12 as pneumatic equipment via the air inflow path 15.

Thus, when the air supply rod 32 is at the projecting position, the on-off valve 36 blocks the communication with the compressed air supply source 41 and the air guide path 37, and when the connection surface 13 is abutted against the projecting surface 33 and the air supply rod 32 reaches a retraction position, the compressed air supply source 41 and the air inflow passage 15 are caused to communicate with each other via the air guide path 37.

A first magnet 47 is provided in the self-propelled dolly 10 so as to expose a surface to the connection surface 13, and a second magnet 48 is provided in the cylinder body 29 of the air supply head 27a so as to exposed the surface to the opposite surface 28. The first and second magnets 47, 48 are annular permanent magnets, and the inlet 14 is at a position of a radially center portion of the first magnet 47, and the outlet 38 is at a position of a radially center portion of the second magnet 48. Polarity of an exposure surface of the magnet 47 and polarity of an exposure surface of the magnet 48 are set to reverse polarity.

The air supply head 27a is attached to the support plate 25 by the elastic member 26, becomes movably in the horizontal direction, and causes the connection surface 13 of the self-propelled dolly 10 to approach the projecting surface 33 of the air supply head 27a. Even if the outlet 38 and the inlet 14 are displaced at a time of the approach, as shown in FIG. 2B, the air supply head 27a is attracted to the self-propelled dolly 10 by a magnetic force and both first and second magnets 47, 48 adhere tightly to each other by a magnetic attraction force. Consequently, the outlet 38 and the inlet 14 are centered so as to be coaxial, and the projecting surface 33 is abutted against the connection surface 13 to communicate the air guide path 37 with the air inflow path 15. Under this condition, when compressed air is discharged from the compressed air supply source 41, compressed air is supplied to the air tank 12 provided in the self-propelled dolly 10.

Thus, the compressed air supply device 20 is a simple structure that has the cylinder body 29 made of a pneumatic cylinder with the air supply rod 32. When the projecting surface 33 of the air supply head 27a is abutted against the connection surface 13 of the self-propelled dolly 10, the outlet 38 becomes a state of communicating with the inlet 14 and compressed air can be supplied to the pneumatic equipment of the self-propelled dolly 10 by using the cylinder body 29 as a communication member for compressed air. In addition thereto, by adhering tightly to the first magnet 47 of the self-propelled dolly 10 and the second magnet 48 of the air supply head 27a by the magnetic attraction force, the outlet 38 and the inlet 14 can be centered with the simple structure and can be communicated with each other. Since the self-propelled dolly 10 and the air supply head 27a are joined by the magnetic force, the sealing force between the projecting surface 33 and the connection surface 13 is increased by the magnetic force. Further, the on-off valve 36 is provided at a base end portion of the air supply rod 32, and when the projecting surface 33 of the air supply rod 32 is abutted against the connection surface 13, the air supply rod 32 has a function of opening the communication path 42. Thus, the air supply rod 32 has a simple structure, but has a function of supplying compressed air to the air inflow path 15 and a function of opening and closing the communication path 42.

As shown in FIGS. 3A and 3B, although the abutment seal member 46 is provided on the projecting surface 33 of the air supply rod 32, the abutment seal member 46 may be provided on the connection surface 13 of the self-propelled dolly 10 and the seal member 46 for sealing a region between the projecting surface 33 and the connection surface 13 may be provided on at least one of the connection surface 13 and the projecting surface 33.

The exposed surface of the first magnet 47 is flush with the connection surface 13 and the exposed surface of the second magnet 48 is flush with the opposite surface 28, so that when the projecting surface 33 is abutted against the connection surface 13, the projecting surface 33 is at a retraction position of being flush with the opposite surface 28. Meanwhile, the exposed surface of the first magnet 47 may be provided on the connection surface 13 so as to protrude from the connection surface 13, and the exposed surface of the second magnet 48 may be provided on the opposite surface 28 so as to protrude from the opposite surface 28. Thus, in a case where at least one of both first and second magnets 47, 48 is projected, when both first and second magnets 47, 48 adhere tightly to each other, the projecting surface 33 is at a retraction position which is a position of protruding from the position shown in FIG. 3B.

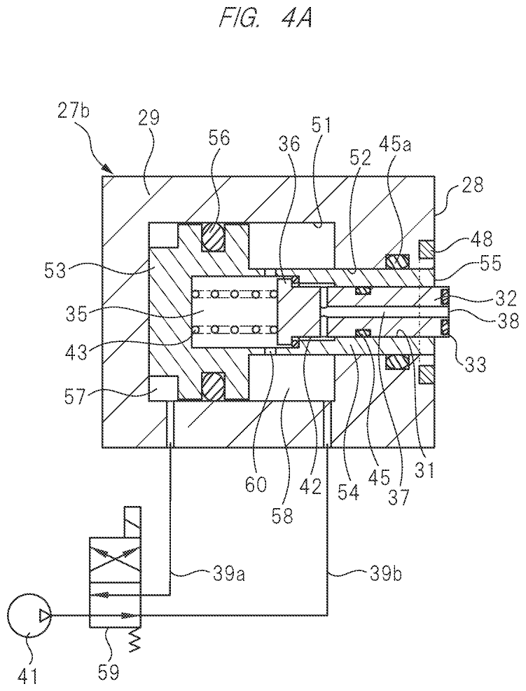

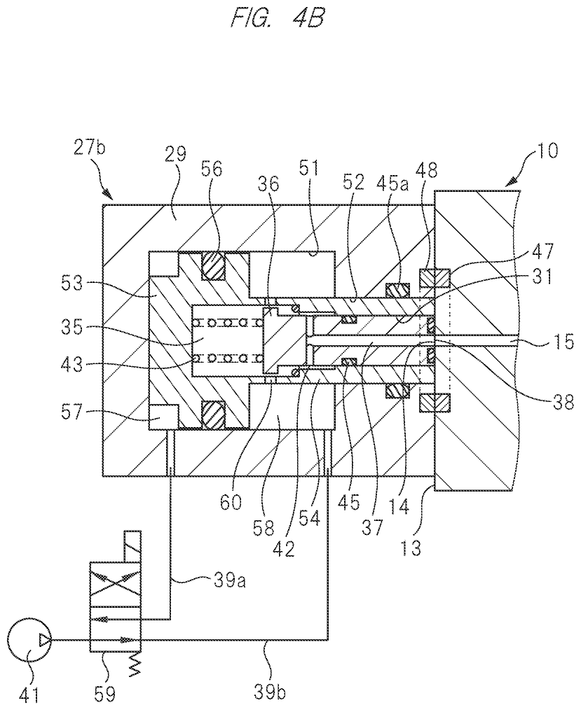

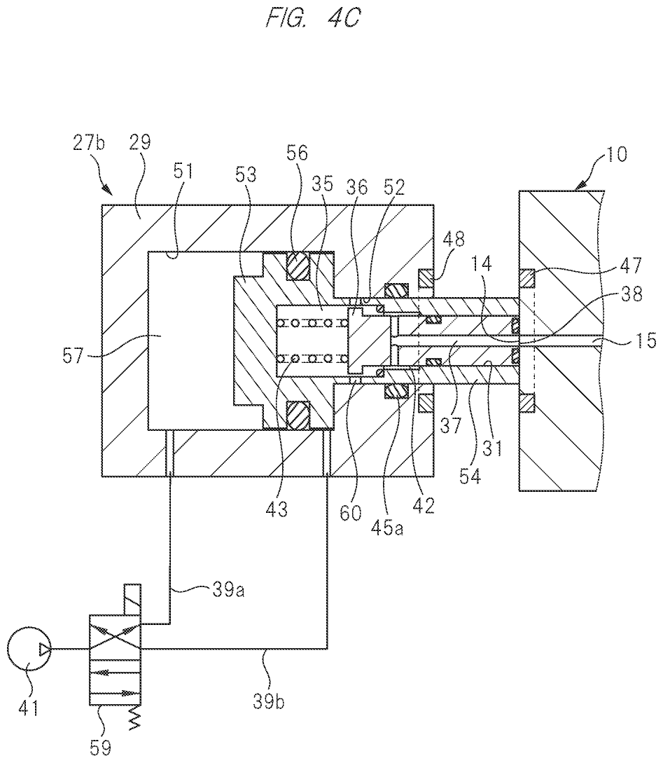

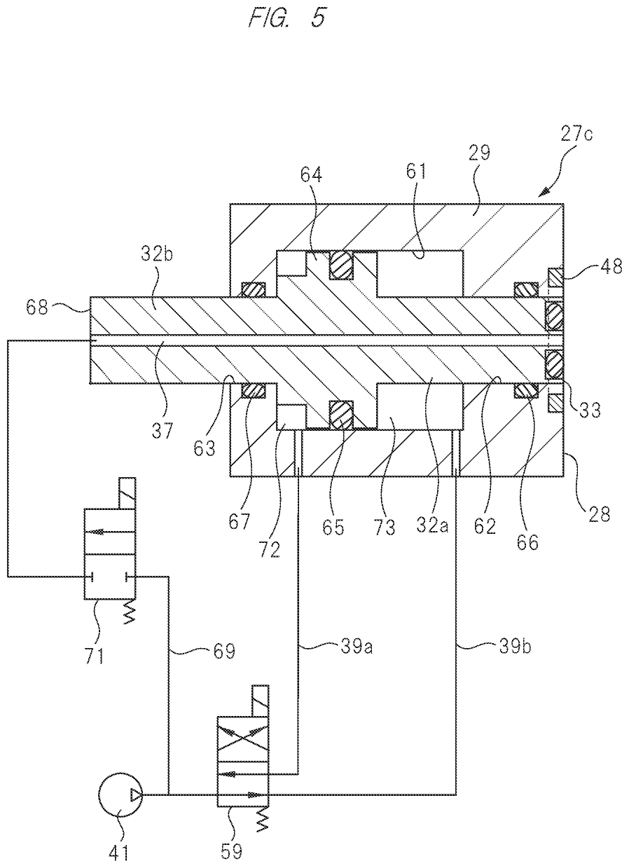

FIGS. 4A to 4C are cross-sectional views each showing an air supply head 27b of a compressed air supply device according to another embodiment. In these figures, members having commonality with the members configuring the above-mentioned air supply head 27a are given the same reference numerals.

A cylinder hole 51 is formed in the cylinder body 29, a small-diameter guide hole 52 communicating with the cylinder hole 51 is formed in the cylinder body 29, and the guide hole 52 opens to the opposite surface 28. A separation piston 53 is reciprocally attached to the cylinder hole 51, and a hollow separation rod 54 provided in the projecting piston 53 is slidably inserted into the guide hole 52. FIGS. 4A and 4B each show a state in which the separation piston 53 has moved to a retraction limit position and, at this time, a tip surface 55 of the separation rod 54 become substantially flush with the opposite surface 28. Meanwhile, FIG. 4C shows a state in which the separation piston 53 is at a forward limit position and, at this time, the tip surface 55 of the separation rod 54 protrudes from the opposite surface.

A sealing member 56 contacting with the cylinder hole 51 is provided in the separation piston 53. A forward air pressure chamber 57 and a backward air pressure chamber 58 are formed by the separation piston 53 provided in the cylinder hole 51. A forward air supply path 39a is connected to the forward air pressure chamber 57, and a backward air supply path 39b is connected to the backward air pressure chamber 58. A channel switching valve 59 is provided between both air supply paths 39a, 39b and the compressed air supply source 41. When the compressed air from the compressed air supply source 41 is supplied to the retraction air pressure chamber 58 via the channel switching valve 59, the separation piston 53 reaches the retraction limit position as shown in FIGS. 4A and 4B. Meanwhile, when the compressed air from the compressed air supply source 41 is supplied to the forward ai pressure chamber 57, the separation piston 53 reaches a forward limit position as shown in FIG. 4C. Note that the sealing member 45a is provided on the inner peripheral surface of the guide hole 52, a region between the outer peripheral surface of the separation rod 54 and the inner peripheral surface of the guide hole 52 is sealed.

The guide hole 31 and the spring chamber 35 are formed in the separation rod 54, the air supply rod 32 is coaxially and movably incorporated in the guide hole 31, and the on-off valve 36 provided at a base end portion of the air supply rod 32 is arranged in the spring chamber 35. The spring chamber 35 communicates with the backward air pressure chamber 58 by the communication hole 60 formed in the separation rod 54, and the spring chamber 35 communicates with the compressed air supply source 41 via the air pressure chamber 58.

As shown in FIG. 4A, under the condition that the separation piston 53 is set at a retraction limit position and the self-propelled dolly 10 and the air supply rod 32 is driven by the spring force and the projecting surface 33 protrudes from the opposite surface 28, when the self-propelled dolly 10 approaches the air supply head 27b, as shown in FIG. 4B, the second magnet 48 of the air supply head 27b adheres tightly to the first magnet 47 of the self-propelled dolly 10 by a magnetic force. Consequently, the outlet 38 is centered so as to coincide with the inlet 14, the air supply rod 32 moves backward against the spring force, and the on-off valve 36 opens the communication path 42. Accordingly, the compressed air discharged from the compressed air supply source 41 is supplied to the air inflow path 15 via the communication hole 60, the communication path 42, and the air guide path 37.

When the air tank 12 is filled with compressed air supplied to the air inflow path 15 and the air tank 12 is completely filled, the channel switching valve 59 is operated to supply compressed air to the forward air pressure chamber 57 as shown in FIG. 4C. Consequently, the separation rod 54 protrudes until the forward limit position against the attraction forces of the first and second magnets 47, 48, and the air supply head 27b is separated from the self-propelled dolly 10. Under the condition that the air supply head 27b is separated from the self-propelled dolly 10, when compressed air is supplied to the backward air pressure chamber 58 by the channel switching valve 59, the separation piston 53 is returned to the retraction limit position as shown in FIG. 4A.

By coaxially arranging the air supply rod 32 inside the separation rod 54, the air supply head 27b of the above-described form is capable of reducing a size of the compressed air supply device provided with the separation mechanism by the simple structure, thereby being able to supply the compressed air to the pneumatic equipment in the self-propelled dolly 10 by the air pressure from the compressed air supply source 41, and separate the air supply head 27b from the self-propelled dolly 10.

FIG. 5 is a cross-sectional view showing an air supply head 26c of a compressed air supply device 20 according to still another embodiment.

The cylinder body 29 of the air supply head 26c is of a double-rod type, and the cylinder hole 61 is formed in the cylinder body 29. A small-diameter guide hole 62 communicating with the cylinder hole 61 is formed in a front end wall portion of the cylinder body 29, and a small-diameter guide hole 63 communicating with the cylinder hole 61 is formed in a back end wall portion of the cylinder body 29. The both guide holes 62, 63 and the cylinder hole 61 are coaxial with each other. The air supply piston 64 is reciprocally attached to the cylinder hole 61, and the air supply rod 32a slidably attached in the guide hole 62 is provided on a front surface side of the air supply piston 64, and the air supply rod 32b slidably attached in the guide hole 63 is provided on a back surface side of the air supply piston 64. The air supply piston 64 and the air supply rods 32a, 32b are integrally formed. A sealing member 65 that contacts with the cylinder hole 61 is provided on the air supply piston 64, and a sealing member 66 that contacts with the air supply rod 32a is provided on the cylinder body 29, and a sealing member 67 that contacts with the air supply rod 32b is provided on the cylinder body 29.

An end surface of the air supply rod 32a is a projecting surface 33, and the air guide path 37 penetrates between an end surface 68 of the air supply rod 32b and the projecting surface 33. In this air supply head 27c, when the projecting surface 33 is caused to contact with the connection surface 13, the projecting surface 33 is substantially flush with the opposite surface 28 and, at this time, the air supply piston 64 is at the retraction limit position. Accordingly, when causing the air supply head 27c to approach the self-propelled dolly 10, the second magnet 48 of the air supply head 27c adheres tightly to the first magnet 47 of the self-propelled dolly 10 by the magnetic force. At this time, the projecting surface 33 is substantially the same retraction position as the opposite surface 28, as shown in FIG. 5.

The air supply path 69 connected to the compressed air supply source 41 is connected to the air supply rod 32b, and an on-off valve 71 is provided in the air supply path 69. The on-off valve 71 switches between a state in which the air supply path 69 is opened and the compressed air discharged from the compressed air supply source 41 is supplied to the air guide path 37 and a state in which the air supply path 69 is blocked. Accordingly, the on-off valve 71 blocks the communication between the compressed air supply source 41 and the air guide path 37 when the projecting surface 33 is separated from the connection surface 13, and communicates with the compressed air supply source 41 and the air inflow path 15 via the air guide path 37 to supply the compressed air to the pneumatic equipment of the self-propelled dolly 10 when the connection surface 13 is abutted against the projecting surface 33.

Before compressed air supply, either of when the projecting surface 33 is away from the connection surface 13 and when the connection surface 13 is abutted against the projecting surface 33, the projecting surface 33 is substantially the same position as that of the opposite surface 28, as shown in FIG. 5. The on-off valve 71 opens the air supply path 69 by an external signal detecting that the connection surface 13 is abutted against the projecting surface 33.

The forward air pressure chamber 72 and the backward air pressure chamber 73 are formed by an air supply piston 64 provided in the cylinder hole 61, the forward air pressure path 39a is connected to the forward air supply chamber 72, and the backward air supply path 39b is connected to the backward air pressure chamber 73. The channel switching valve 59 is provided between both air supply paths 39a, 39b and the compressed air supply source 41. When the compressed air of the compressed air supply source 41 is supplied to the backward air pressure chamber 73 via the channel switching valve 59, the air supply piston 64 is at a backward limit position, as shown in FIG. 5. Meanwhile, when the compressed air of the compressed air supply source 41 is supplied to the forward air pressure chamber 72, the air supply piston 64 is at the forward limit position and the projecting surface 33 of the air supply rod 32a protrudes in front of the opposite surface 28 from the position shown in FIG. 5

When the projecting surface 33 protrudes, the second magnet 48 of the air supply head 27c is separated from the first magnet 47 of the self-propelled dolly 10. Thus, the air supply rod 32 also functions as a separation rod for separating the air supply head, which is attracted by the self-propelled dolly 10, from the self-propelled dolly 10.

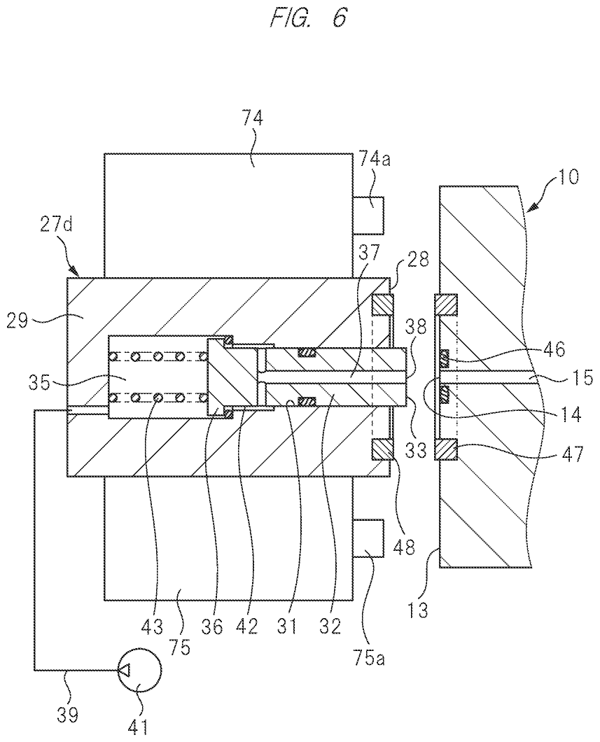

FIG. 6 is a cross-sectional view showing an air supply head 27d of a compressed air supply device 20 according to still another embodiment.

The cylinder body 29 has substantially the same basic structure as the cylinder body 29 shown in FIGS. 3A and 3B, and an air supply rod 32 is reciprocally attached in a guide hole 31 formed in the cylinder body 29. The on-off valve 36 integrated with the back end portion of the air supply rod 32 is arranged in the spring chamber 35, and the compression coil spring 43 applies a spring force to the on-off valve 36 and the air supply rod 32 in a direction toward the forward limit position. An outlet 38 of the air guide path 37 formed in the air supply rod 32 is open to the projecting surface 33, and the air guide path 37 communicates with the spring chamber 35 via the communication path 42.

Two separation cylinders 74 and 75, each of which is configured from an air cylinder, are attached to the cylinder body 29 of the air supply head 27d. The respective separation cylinders 74, 75 have separation rods 74a, 75a projecting forward. When the supply head 27d is separated from the connection surface 13 after abutting the projecting surface 33 against the connection surface 13 and causing the air guide path 37 to communicate with the air inflow path 15 to supply the compressed air to the pneumatic equipment of the self-propelled dolly 10, the respective separation rods 74a, 75a of the separation cylinders 74, 75 are protruded. The number of separation cylinders attached to the air supply head 27d is not limited to two. However, if a plurality of separation cylinders are attached, the air supply head 27d can be separated from the self-propelled dolly 10 without tilting.

The abutment seal member 46 for sealing a region between the connection surface 13 and the projecting surface 33 is provided on the connection surface 13 unlike the above-described embodiment. That is, the abutment seal member 46 is provided in the annular groove formed in the connection surface 13. In each of the air supply heads 27a to 27c described above, the abutment seal member 46 may be provided on the connection surface 13 as well.

As shown in FIG. 6, the first magnet 47 provided on the connection surface 13 protrudes slightly from the connection surface 13. Similarly, the second magnet 48 provided on the opposite surface 28 protrudes slightly from the opposite surface 28. In this case, when both first and second magnets 47, 48 contact with each other and the projecting surface 33 contacts with the connection surface 13, the opposite surface 28 does not contact with the connection surface 13. Also in the air supply heads 27a to 27c having the respective forms described above, each of the magnets 47, 48 may be protruded.

Each of the first and second magnets 47, 48 is an annularly formed integral type, but by attaching the plurality of magnets at the same radial position from the center of the inlet 14, the first magnet 47 on the connection surface 38 side may be formed by a plurality of magnet pieces. Similarly, by attaching the plurality of magnets at the same radial position from the center of the outlet 38, the second magnet 48 on the opposition surface 28 side may be formed by a plurality of magnetic pieces. The respective surfaces of the first and second magnets 47, 48 are exposed to the outside, but they may be covered with a thin protective film. Also, either one or both of the first and second magnets 47, 48 may be electromagnets.

The various embodiments of the invention are not limited to the above-described embodiments, and various modifications can be made without departing from the gist of the present invention. This compressed air supply device 20 is suitable when the self-propelled dolly 10 cannot be positioned at a predetermined position of the air supply head. can also be applied to Although the self-propelled dolly 10 is shown as a moving device or moving object, it is not limited to the self-propelled dolly 10, and may be used to supply compressed air to a moving object on which pneumatically operated equipment is mounted. For example, the present invention can be applied to any object. Pneumatic devices to which compressed air is supplied include not only air tanks for supplying compressed air to pneumatic actuators and pneumatic control devices, but also pneumatic actuators and pneumatic control devices as pneumatic devices that directly compress air. Air may be supplied.

The compressed air supply device of the present invention can be used to supply compressed air to pneumatic equipment incorporated in a moving device.

What is claimed is:

1. A compressed air supply device supplying compressed air to pneumatic equipment mounted on a moving device from an inlet of an air inflow path that communicates with the pneumatic equipment, the compressed air supply device comprising:
an air supply head provided with an opposite surface opposing a connection surface that is provided with the inlet, and attached to a support member;
an air supply rod reciprocably arranged at the air supply head between a projecting position where the projecting surface protrudes from the opposite surface and a retraction position where the projecting surface recedes from the projection position;
an air guide path formed in the air supply rod and provided with an outlet on the projecting surface;
an on-off valve blocking communication between a compressed air supply source and the air guide path when the connection surface separates from the connection surface, and causing the compressed air supply source and the air inflow path to communicate with each other via the air guide path when the connection surface is abutted against the projecting surface;
a first magnet provided on the connection surface; and
a second magnet provided on the opposite surface, and magnetically attracted at the first magnetic to center the outlet to the inlet.

2. The compressed air supply device according to claim 1, wherein:
the on-off valve is provided in the air supply rod; and
the on-off valve blocks communication between the compressed air supply source and the air guide path when the air supply rod is at the projecting position, and communicates with the compressed air supply source and the air inflow path via the air guide path when the connection surface is abutted against the projecting surface and the air supply rod is at retraction position.

3. The compressed air supply device according to claim 1,
wherein a separation rod is provided in the air supply head, the separation rod causing the air supply head to separate from the connection surface against an absorption force of the first magnetic and the second magnetic.

4. The compressed air supply device according to claim 1, further comprising a separation piston movably attached into a cylinder hole formed in the air supply head, and wherein:
a hollow separation piston in which the air supply rod is movably incorporated is provided on the separation piston; and
the separation rod is driven by the separation piston.

5. The compressed air supply device according to claim 3, wherein the air supply head is provided with a separation cylinder for driving the separation rod.

6. The compressed air supply device according to claim 1, further comprising an air supply piston movably attached in a cylinder hole formed in the air supply head and integrally provided with the air supply rod, and wherein:
the on-off valve is provided in an air supply path connected to the air guide path of the air supply rod; and
the air supply piston moves between a retraction position where the projecting surface contacts with the connection surface and a projection position where the air supply head is separated from the connection surface.

7. The compressed air supply device according to claim 1, wherein a surface of the first magnet is substantially flush with the connection surface, and a surface of the second magnet is substantially flush with the opposite surface.

8. The compressed air supply device according to claim 1, wherein an abutment seal member is provided on at least one of the connection surface and the projecting surface.

9. The compressed air supply device according to claim 1, wherein one or both of the first magnet and the second magnet are electromagnets.
